(19) United States
(12) Patent Application Publication
(10) Pub. No.: US 2026/0101905 A1
(43) Pub. Date: Apr. 16, 2026

(54) VEGAN CREAMS AND ICE CREAMS

(71) Applicant: Dug FoodTech AB, Lund (SE)

(72) Inventor: Eva TORNBERG, Lund (SE)

(21) Appl. No.: 18/850,474

(22) PCT Filed: Mar. 28, 2023
(86) PCT No.: PCT/SE2023/050276

§ 371 Date: Sep. 24, 2024

(30) Foreign Application Priority Data
Mar. 28, 2022 (SE) 2250375-9

(51) Int. Cl. A23C 11/10; A23G 9/32; A23G 9/38; A23G 9/42; A23G 9/46; A23L 19/12

(52) U.S. Cl. CPC A23C 11/10; A23G 9/327; A23G 9/38; A23G 9/42; A23G 9/46; A23L 19/12

(57) ABSTRACT

The present invention relates to a vegan, non-dairy composition of an emulsion which may be used to form a whippable cooking cream and an ice-cream comprising 0.1-2% by weight heat treated, dehydrated potato as a stabilizer; 8-40% by weight vegetable fat mix; 2-25% by weight of at least one sweetening agent; 0.5-5% by weight of at least one added vegetable protein; 0.2-1.2% by weight mono- or diglyceride, or mixture thereof; 1-8% by weight maltodextrin; and water adding up to 100% by weight.

### TECHNICAL FIELD OF THE INVENTION

The present invention relates to a vegan, non-dairy composition which may be used as such in cooking or as an aerated emulsion e.g. as vegan cream or ice cream and to the use of said vegan, non-dairy composition.

### BACKGROUND ART

Veganism is steadily growing throughout the world and means refraining from the use or consumption of animal products. Vegan food does not contain any animal-derived components, animal products or byproducts. Thus, vegan food only contains plant-based components.

Dietary vegans refrain from consuming animal products, not only meat but also eggs, dairy products and other animal-derived substances. This is a challenge and an opportunity for the food industry in preparing alternatives for certain existing animal derived food products and beverages.

Creams, aerated creams and ice-creams are very popular in desserts and snacks during summer, but not only that ice-cream has become a more common food item on a more daily basis due to the available freezers at home. Vegan based creams and ice creams have started to occur on the market but the market share is still very small but increasing compared to dairy based creams and ice creams. In addition, the available vegan based creams and ice creams have drawbacks such as low creaminess.

An ice-cream can be defined as a frozen whipped cream, where the cream is an emulsion consisting of a two-phase system of immiscible liquids, one of them being dispersed into the other in the form of fine droplets. A stable emulsion can slowly undergo various processes which result in the separation of the oil and the water phases, which can be hindered by a stabiliser. An emulsion of two liquids without a stabilizer will quickly separate into two liquid layers. To prepare a stable emulsion, substances (surfactants) must be added which have an influence on the interfacial properties by forming an energy barrier, which prevents close contact between the emulsified droplets.

A large majority of the emulsifiers used in the food industry are solid particles or proteins, but it can also consist of amphiphilic compounds of medium molecular weight, emulsifiers such as monoglycerides. Owing to their amphiphilic character, these substances forcefully absorb to the interface between oil and water causing a pronounced reduction of the interfacial tension.

In whipped cream air is whipped into the emulsion so a foam can be generated, where the foam bubbles should be stabilised. A controlled destabilization of the emulsion is needed to develop an internal structure of agglomerated fat, which adhere to the air bubbles and stabilises them and thereby favourably alters the texture and physical appearance of the product. Whipped cream relies heavily on controlled destabilization of the emulsion for the development of structure as it is converted from a viscous liquid into a viscoelastic solid during the process of whipping. The solidification of the water phase in the ice-cream is generated by the ice crystals that are formed during the contemporaneous cooling and aeration giving a network of small ice crystals.

The structure of whipped dairy cream has been studied by electron microscopy, and it was demonstrated that the air bubbles in the foam are surrounded by a layer of fat globules which partially protrude into the air bubbles. Furthermore, it was observed that the adsorbed fat globules have lost their protective membrane layers and that liquid fat was presented in open spaces between solid fat globules.

Monoglycerides of short-chain fatty acids are powerful destabilizers, whereas monoglycerides of longer chain fatty acids are not so effective. An essential function of the monoglyceride is to act as a destabilizing agent in a whippable emulsion, where the adsorption of partially destabilized fat globules at the air-water interface around the cells determines the foam stability, texture and mouth feel.

WO 2019/079669 discloses a plant-based culinary créme containing water, fat, sweetener, plant-based protein and non-dairy milk powder. It is disclosed that the culinary creme forms an unstable emulsion (eg matrix or foam) when whipped, meaning that it reverts back to its liquid form after being whipped or vigorously stirred, which is different from the present context. It may be used in frozen desserts or ice creams.

CN105192239 discloses a color potato ice cream which contains e.g. 30-40 parts mashed potatoes, 4-8 parts whole milk powder, 2-5 parts butter, egg. Thus, the disclosed potato ice cream is not vegan.

JP58212749 discloses a dairy ice cream containing potato puree. It contains egg yolk and cream. Therefore, it is not vegan.

CN101292701 discloses a potato product containing potato pulp, cyclodextrin and hydroxymethyl cellulose and white sugar.

There is a need within the technical field to provide improved vegan creams and frozen creams such as frozen desserts and ice cream because of the drawbacks of the available vegan frozen products. Such drawbacks include consistency drawbacks, low smoothness and bad taste including off flavours.

### SUMMARY OF THE INVENTION

Thus, according to the present invention there has been provided a new type of vegan, non-dairy composition for use in an aerated emulsion comprising;
0.1-2% by weight heat treated, dehydrated potato as a stabilizer;
8-40% by weight vegetable fat mix;
2-25% by weight at least one sweetening agent;
0.5-5% by weight at least one added vegetable protein;
0.2-1.2% by weight mono- or diglyceride, or mixture thereof;
1-8% by weight maltodextrin; and
water adding up to 100% by weight.

As will be discussed below and in the experimental part, sensory investigations of the vegan, non-dairy composition when used as a frozen aerated emulsion such as an ice cream has superior creaminess and improved properties compared to prior art vegan frozen, aerated emulsions as well as dairy ice creams.

In another aspect of the invention, there has been provided use of above mentioned vegan, non-dairy composition, wherein the vegan, non-dairy emulsion is aerated and/or is whippable to provide a stable foam.

In another aspect there has been provided an aerated, optionally frozen, vegan non-dairy emulsion such as a whipped cream or ice cream.

### FIGURES

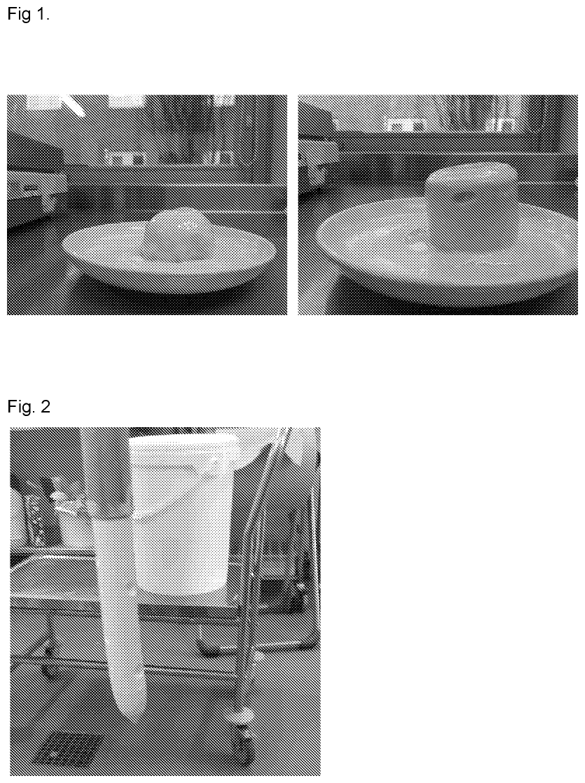

In FIG. 1 the melting behaviour of an aerated, frozen emulsion (containing fat mix, heated, dehydrated potato, veg. protein, sugar, citrem and water) without maltodextrin is seen to the left and an aerated and frozen emulsion (containing fat mix, heated, dehydrated potato, veg. protein, sugar, maltodextin and water) with maltodextrin can be seen to the right in the photographs. The combination of heated, dehydrated potato and maltodextrin makes the ice-cream to melt slower, which is seen in the right hand photograph.

In FIG. 2 there is disclosed a frozen, vegan aerated emulsion i.e. vegan ice-cream coming out of the ice-cream machine. It was smooth and white in appearance similar to a dairy ice cream.

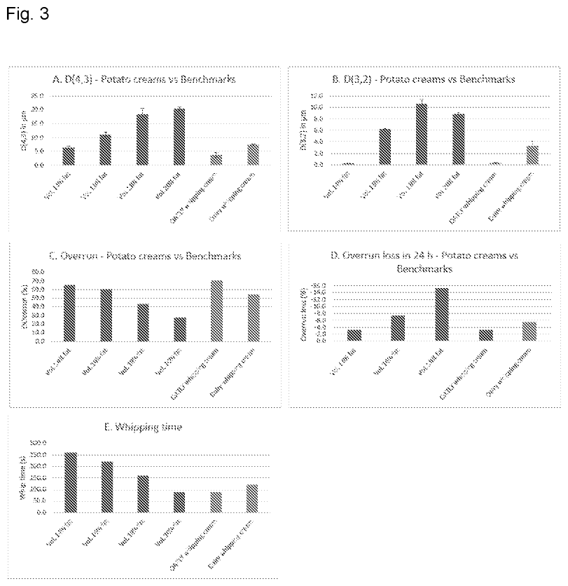

In FIG. 3, the whippable creams of the invention are compared to dairy whippable cream and Oatly iMat visp (whippable oat cream). The particle size, overrun, and overrun loss are all shown in FIG. 3.

### DEFINITIONS

By the term “heat treated, dehydrated potato” it is herein meant a source of potato being heated firstly to above 95° C., such as to about 98-100° C., e.g. to at least 100° C., and 115-121° C. and thereafter the potato is dehydrated in order to remove water. A drum dryer may e.g. be used for the dehydration. By the term “vegetable oil” it is meant oil that is obtained from vegetable sources. The preferred sources are further described below.

By the term ‘source of potato’ and ‘potato’ it is herein meant potato in any form and from any origin. The potato may for example be in the form of potato flakes or as whole potato or potato cubes or potato mash. However, there is no limitations in the form of the potato.

By the term “potato flake” it is herein meant whitish flakes which have been heated first and thereafter dehydrated for removing water, where 30-65% of the flakes have a size of the non-limiting range of 1-3 mm. The potato flakes may be bought as they are or be prepared according to described procedures for heating and dehydrating.

By the term “potato cube” it is herein meant cubes of potato, or substantially cube formed potato, with about a non-limiting 10 mm side length.

### DETAILED DESCRIPTION OF THE INVENTION

As have been described above there has been provided a vegan, non-dairy composition comprising;
0.1-2% by weight heat treated, dehydrated potato as a stabilizer;
8-40% by weight vegetable fat mix;
2-25% by weight at least one sweetening agent;
0.5-5% by weight at least one added vegetable protein;
0.2-1.2% by weight mono- or diglyceride, or mixture thereof;
1-8% by weight maltodextrin; and
water adding up to 100% by weight.

The specific combination of technical features of the vegan, non-dairy composition when used to provide an aerated emulsion such as in ice cream provides beneficial features such as superior creaminess. The melting behavior is also superior which can be seen in the examples. The specific combination has also been proved to be aerated and/or whippable to provide a stable foam even at such low-fat contents as 14%.

In an embodiment a vegan, non-dairy composition is provided, wherein heat treated, dehydrated potato in an amount of 0.1-2% by weight is used as a stabilizer is chosen from potato flakes. The potato flakes may have been heated to at least 100° C. and thereafter dehydrated. The dehydration may be performed by increasing the surrounding temperature for instance by placing the heat-treated potato on a drum dryer. Water is evaporated quickly without disturbing the structure of the starch granules. Whole and/or potato cubes may also be used which have been pasteurized at at least 98° C. or have been autoclaved at about 115-121° C. Water is evaporated quickly without disturbing the structure of the starch granules. The heat treated, dehydrated potato may be present in an amount of 0.1, 0.2, 0.3, 0.4, 0.5, 0.6, 0.7, 0.8, 0.9, 1.0, 1.1, 1.2, 1.3, 1.4, 1.6, 1.7, 1.8, 1.9, 2.0% by weight of the final composition. By using heat treated, dehydrated potato as a stabilizer in the composition there is no need to use carrageenan and/or guar gum, which is generally used in ice-creams. Using potato is also beneficial from a sustainability perspective since it is the crop that gives the most food per cultivated area especially in the Nordic countries.

It has been shown according to the present disclosure that the addition of heat treated, dehydrated potato e.g. potato flakes assists in stabilising an aerated emulsion, i.e. a foam, which is suitable when preparing an ordinary whipped cream or frozen desert such as ice cream. The standing time of a frozen vegan emulsion as described herein was longer than for the dairy-based emulsions, i.e. ordinary dairy ice-cream, that melted quicker.

In an embodiment the composition is an emulsion which is suitable for being aerated for providing a stable foam. Said foam may be used as an alternative to ordinary dairy whipped cream. Said foam may also be frozen which may be used as an alternative to dairy ice cream.

In order to make a vegan ice-cream the dairy ingredient e.g. milk in the basic emulsion has to be substituted. The fat in milk is solid to a certain degree at room temperature and this is not the case with a vegetable oil such as rape seed oil, which is totally liquid at that temperature. Therefore, different mixtures of vegetable oils, such as rape seed oil and shea oil and coconut oil have been evaluated in the experimental part. The fat mixes for e.g. ice-cream have typically a solid fat content of 0.5-20% by weight at 30° C., a solid vegetable fat content of 12-30% by weight at 20° C., and a vegetable solid fat content of 26-45% at 10° C. For the whipped cream the solid fat content is up to 47% by weight at 30° C., a solid vegetable fat content of up to 82% by weight at 20° C., and a vegetable solid fat content of up to 94% at 10° C. The reason for these requirements of the fat phase of the emulsion is that the controlled destabilization of the emulsion absorbed at the air bubbles described above cannot occur if not part of the fat is solid.

In embodiments the vegetable fat mix is present in amount of the composition 8-40% by weight, for instance in amount 10-30, or 15-25% by weight, e.g. 9, 10, 11, 12, 13, 14, 15, 16, 17, 18, 19, 20, 21, 22, 23, 24, 25, 26, 27, 28, 29, 30, 31, 32, 33, 34, 35, 36, 37, 39% by weight.

In an exemplary embodiment the vegan, non-dairy composition comprises a vegetable fat mix having a solid vegetable fat content of 4-12% by weight at 30° C., a solid vegetable fat content of 18-26% by weight at 20° C., and a vegetable solid fat content of 26-34% by weight at 10° C.

In another exemplary embodiment the vegan, non-dairy composition comprises a vegetable fat mix having a solid vegetable fat content of 6-10% by weight at 30° C., a solid vegetable fat content of 20-24% by weight at 20° C., and a solid vegetable fat content of 28-32% by weight at 10° C.

In another exemplary embodiment the vegan, non-dairy composition comprises a vegetable fat mix having a solid vegetable fat content of 8% by weight at 30° C., a solid vegetable fat content of 22% by weight at 20° C., and a solid vegetable fat content of 30% by weight at 10° C.

The vegan, non-dairy composition may comprise at least one sweeting agent in amount of 2-25% by weight, e.g. 3-24, 4-23 or 5-22, or 6, 7, 8 or 9% by weight, such as 10-25%, such as 15-20% by weight, e.g. 13, 14, 15, 16, 17, 18, 19% by weight, which sweetening agent is selected from the group consisting of monosaccharide, disaccharide, polysaccharide and polyol. The sweetening agent can be comprised of one or more sugars such as sucrose, fructose, dextrose, or glucose. Any other artificial sweeting agents such as aspartame and/or stevia may also be used. The added sugar or any other sweetening agent provides a sweet taste and conceals the taste of the potato which may be undesirable. A flavoring agent may also conceal the taste of the potato.

The vegan, non-dairy composition may comprise 1-8% by weight such as 2-7, e.g. 3, 4, 5, 6% by weight, maltodextrin having a low dextrose equivalent (DE) such as 1-5 DE such as 1, 2, 3, 4 or 5 dextrose equivalents. It has been shown according to the present disclosure that the addition of maltodextrin to the vegan composition improves the creaminess of a final frozen vegan emulsion significantly.

The vegan, non-dairy composition may comprise an added vegetable protein in an amount of 0.5-5% by weight, e.g. 1, 1.5, 2, 2.5, 3, 3.5, 4, 4.5% by weight vegetable protein, that is selected from the group consisting of pea protein, potato protein, and soy protein. The protein may be present as a powder such a pea protein powder, potato protein powder or soy protein powder. Any other vegetable protein or protein powder may naturally be used. The protein may be present as a protein isolate with high protein content.

The vegan, non-dairy composition may further comprise a flavoring agent such as chocolate, vanilla, or any fruit flavoring agent. Natural or artificial fruit flavoring agents may be used. Flavoring agents may be added to the aerated emulsion as such or in case the emulsion is to be frozen. Thereby, there is provided a final frozen aerated emulsion being a vegan alternative to dairy ice-cream.

The vegan, non-dairy composition may comprise mono- and diglycerides or mixture thereof in an amount of 0.2-1.2% by weight, e.g. 0.3, 0.4, 0.5, 0.6, 0.7, 0.8, 0.9, 1.0, 1.1% by weight, and selected from the group consisting of lactic acid esters of mono- and diglycerides such as lactem, and citric acid esters of mono and diglycerides such as citrem, or datem which is diacetyl tartaric acid ester of mono- and diglycerides.

The vegan, non-dairy composition may additionally comprise at least one pH regulating agent. Any pH regulating agent ordinary for consumption may be used, examples of pH regulating agents are Na₂HPO₄—NaH₂PO₄ and K₂HPO₄—KH₂PO₄. The pH agent is added in order to increase the pH to typically 6.5 to 7.5, especially to 6.5 to 7.0.

In an exemplary embodiment, a vegan, non-dairy composition comprises the following;
0.75-1.25% by weight heat treated, dehydrated potato as a stabilizer;
10-20% by weight vegetable fat mix,
2-15% by weight of at least one sweetening agent;
1-3% by weight of at least one added vegetable protein;
0.5-1% by weight mono- or diglyceride;
2-5% by weight maltodextrin; and
water adding up to 100% by weight.

In an exemplary embodiment, a vegan, non-dairy composition comprises the following;
0.75-1.25% by weight heat treated, dehydrated potato as a stabilizer;
10-14% by weight vegetable fat mix,
2-15% by weight of at least one sweetening agent;
1-3% by weight of at least one added vegetable protein;
0.5-1% by weight mono- or diglyceride;
2-5% by weight maltodextrin; and
water adding up to 100% by weight.

The requirements of the fat mixes for the ice-cream are that they have a solid fat content of 0.5-20% by weight at 30° C., a solid vegetable fat content of 12-30% by weight at 20° C., and a vegetable solid fat content of 26-45% at 10° C. For the whipped cream the solid fat content is up to 47% by weight at 30° C., a solid vegetable fat content of up to 82% by weight at 20° C., and a vegetable solid fat content of up to 94% at 10°.

In an embodiment, there is provided a frozen, vegan non-dairy composition such as an emulsion which is suitable for replacing dairy frozen emulsions such as an ice-cream. In an embodiment of the invention the composition as described above is in the form of an emulsion e.g. aerated emulsion.

All embodiments described above for the composition also apply to the case of an emulsion as such or to be whipped.

In an embodiment there is provided use of a vegan, non-dairy composition e.g. in the form of an emulsion as described above, wherein the vegan, non-dairy emulsion is aerated and/or is whippable to provide a stable foam. The heat treated, dehydrated potato stabilizes the foam, which is beneficial in view of its natural origin.

In another embodiment there is provided use of a vegan, non-dairy composition as described above, wherein the vegan, non-dairy composition is aerated and thereafter frozen to provide a frozen desert or ice cream. There is also provided a frozen aerated vegan, non-dairy emulsion such as a vegan ice cream.

### EXAMPLES

By way of examples, and not limitation, the following examples identify a variety of compositions pursuant to embodiments of the present invention.

A source of heat treated, dehydrated potato is included in the composition.

### The Processing of a Vegan Aerated Emulsion

In order to make a vegan aerated emulsion such as ice-cream the dairy ingredient e.g. milk in the basic emulsion has to be substituted. The fat in milk is solid to a certain degree at room temperature and this is not the case with a vegetable oil such as rape seed oil, which is totally liquid at that temperature. Therefore, different mixtures of vegetable oils, such as rape seed oil and shea oil and coconut oil have been evaluated as a fat phase in example 4. The requirement of the fat mixes for the ice-cream is that they have a solid fat content of 0.5-20% by weight at 30° C., a solid vegetable fat content of 12-30% by weight at 20° C., and a vegetable solid fat content of 26-45% at 10° C. For the whipped cream the solid fat content is up to 47% by weight at 30° C., a solid vegetable fat content of up to 82% by weight at 20° C., and a vegetable solid fat content of up to 94% at 10° C. The reason for these requirements of the fat phase of the emulsion is that the controlled destabilization of the emulsion absorbed at the air bubbles described above cannot occur if not part of the fat is solid.

When making the emulsion the fat has to be liquid (above 40° C.) and therefore the pre-mix consisting of the fat phase and an emulsifier in the form of a vegetable protein has to be pasteurised at least 4 s at 85° C. before being homogenised in a valve homogeniser at a pressure of 150-600/50 bars. Thereafter the vegetable emulsion is ripened overnight in a fridge (+5° C.).

The next day the aerated emulsion is made in an ice-cream machine consisting of a valve where air is pumped into the emulsion and the cooling is performed in a scrape heat exchanger to form ice crystals in the water phase giving a frozen aerated emulsion i.e. ice-cream of about −4° C. coming out of the ice-cream machine. To make this frozen aerated emulsion harder it must be stored in a freezer for a certain time.

The Evaluation of a Frozen Aerated Emulsion e.g. Ice-Cream

To evaluate the properties of the vegan aerated emulsion the following has been measured:

### Particle Size Distribution:

The particle size distribution (PSD) of the ice-cream mix emulsion and the melted ice-cream emulsion was measured as D[3,2] and D[4,3] using a laser diffraction analyser (Malvern Mastersizer). The mean particle size can be calculated based on the volume or the area occupied by the particles, expressed as d₄₃ (also written as D[4,3]) and d₃₂ (also written as D[3,2] herein), respectively.

$${d}_{43} = {\sum }_{i} {n}_{i} {d}_{i}^{4} / {\sum }_{i} {n}_{i} {d}_{i}^{3}$$

$${d}_{32} = {\sum }_{i} {n}_{i} {d}_{i}^{3} / {\sum }_{i} {n}_{i} {d}_{i}^{2}$$

Where nᵢ is the percentage of particles with diameter di.

### Overrun:

The emulsion before and after the ice-cream machine was weighed in one dl. Overrun (%) was calculated according the following formula and will reflect the amount of air that will be incorporated into the emulsion during cooling and aeration.

$$overrun = \frac{weight emulsion - weight ice - cream}{weight emulsion} * 100 ( \% )$$

### Melting Behaviour:

Melting was followed by cutting a 2 cm thick slice from the frozen aerated emulsion i.e. ice-cream stored in a cylinder of a diameter of 5 cm. This slice was put on a net (3 holes per cm) where the amount of melted ice-cream was measured in a cup below as a function of time.

### Standing Time

The standing-time of the prepared frozen vegan aerated emulsions was also evaluated.

### Sensory Evaluation:

On a scale from 1 to 4 (from none to high) icy, taste, melting in the mouth, creaminess and total impression has been evaluated by 4 assessors.

### Example 1

To Find Out how Heat Treated, Dehydrated Potato Influences the Properties of a Frozen Areated Emulsion i.e. Vegan Ice-Cream and Compared to Dairy Ice-Cream

### Compositions

The compositions of two vegan ice-cream mixtures with and without heat treated, dehydrated potato can be seen in Table 1. The fat used is completely vegetarian and has been obtained from AKO Karlshamn with shea fat (Akomix LS 25) and it has 7% solid fat at 30° C., 19% solid fat at 20° C. and 26% solid fat at 10° C. Potato flakes in size of 1-3 mm were provided by Eko Kebelco

TABLE 1
Compositions of two ice-cream mixes
1a and 1b with and without potato

| | Vegan Ice-cream | Vegan Ice-cream |
|---|---|---|
| | mix 1a | mix 1b |
| Ingredients | [%] | [%] |
| Akomix LS 25 | 12 | 12 |
| Heat treated and | 1 | 0 |
| dehydrated potato | | |
| (potato flakes) | | |
| Pea protein | 3 | 3 |
| Sugar | 20 | 20 |
| Vanillin sugar | 5 | 5 |
| Water | 64 | 65 |
| Total | 100 | 100 |

As a comparison, two dairy based ice creams were used with the ingredients as shown in Table 2.

TABLE 2
Dairy ice-cream based on cream with high fat
content (20%) and low fat content (12%)

| | Dairy Ice-cream | Dairy Ice-cream |
|---|---|---|
| | mix 2a | mix 2b |
| Ingredients | [%] | [%] |
| Cream 38% | 50 | 27 |
| Milk 3% | 33 | 56 |
| Sugar | 17 | 17 |
| | 100 | 100 |

### Production of the Vegan Ice-Cream

The fat was melted and the rest of the ingredients were mixed in a vessel at a temperature of 50° C. and mixed for two minutes. The temperature of 40° C. of the mix was maintained in a water bath until valve homogenisation at 190/50 bar. The emulsion was then ripened in a fridge at least for 2 hours. Thereafter the vegan ice-cream was produced in an ice-cream machine holding −20° C. for half an hour and the ultimate temperature of the ice-cream was −2° C. The ice-cream mix started to crystallise after 15 min.

### Characterisation of the Vegan Ice-Cream

In Table 3 the measured properties of the vegan ice-creams can be seen. The particle size distribution (PSD) was in this case only measured for the ice-cream with potato and the D[3,2], i.e. the smaller particles was in a good size area being 1.6 μm and the D[4,3] equal to 33 μm is not too large either.

TABLE 3
The properties of an ice-cream with and without potato
and for a dairy cream with low and high fat content

| | | | | | Stand- | |
|---|---|---|---|---|---|---|
| | | D[3, 2] | D[4, 3] | Overrun | time | |
| Sample | Description | (μm) | (μm) | (%) | (min) | Sensorial comments |
| Vegan | Composition | 1.6 | 33.0 | 10.6 | >90 | Icy and somewhat |
| Ice- | with potato | | | | | grainy |
| cream | | | | | | |
| mix 1a | | | | | | |
| Vegan | Composition | | | 1.8 | 80 | Icy and somewhat |
| Ice- | without | | | | | grainy |
| cream | potato | | | | | |
| mix 1b | | | | | | |
| Dairy | Ice-cream | | | 15.1 | 60 | Evident taste of |
| ice- | with high fat | | | | | dairy cream and |
| cream | content | | | | | smooth consistency |
| mix 1c | (20%) | | | | | |
| Dairy | Ice-cream | | | 25.0 | 60 | Evident taste of |
| ice- | with low fat | | | | | dairy cream and |
| cream | content | | | | | smooth consistency |
| mix 1d | (12%) | | | | | |

The overrun was the best for the dairy ice-cream, varying from 15 to 25% depending on the fat content, but still this overrun is low compared to industrially produced ice-creams usually having an overrun about 100%. This shows that it is difficult to achieve a high overrun in a lab-scale ice-cream machine, but we can still make comparisons between different compositions. It can be noted that the vegan ice-cream had lower overruns than the dairy-based ice-cream. Especially the vegan ice-cream without heat treated, dehydrated potato obtained such a low overrun around 2% compared to the one with heat treated, dehydrated potato with 10.6% overrun. Evidently, the heat treated, dehydrated potato helps to stabilise the emulsion foam in the ice-cream. The standing time of the vegan ice-creams was longer than for the dairy-based ice-creams that melted quicker. The longest standing time was achieved for the vegan ice-cream with heat treated, dehydrated potato. Thus, the above experiment has shown that the presence of heat treated, dehydrated potato has an important stabilising effect on the ice-cream, which is an important property when preparing vegan aerated emulsions such as cream and ice-cream.

### Example 2

### The Influence of the Addition of a Monoglyceride and Maltodextrin on the Properties of Vegan Ice-Cream

### Compositions

In table 4 four new compositions of vegan ice-cream mixes, where in the first composition a monoglyceride (Citrem) has been added, in the second one 5% of the sugar has been exchanged with a maltodextrin with low DE (2-3 dextrose equivalents) and in the two last compositions (2c and 2d) a combination of both Citrem and maltodextrin has been evaluated.

TABLE 4
Compositions of the four vegan ice-cream mixes 3a, 3b, 3c and 3d

| | Vegan | Vegan | Vegan | Vegan |
|---|---|---|---|---|
| | Ice- | Ice- | Ice- | Ice- |
| | cream | cream | cream | cream |
| | mix 2a | mix 2b | mix 2c | mix 2d |
| Ingredients | (%) | (%) | (%) | (%) |
| Akomix LS 25 | 12 | 12 | 12 | 12 |
| Potato flakes | 1 | 1 | 1 | 1 |
| Pea protein | 3 | 3 | 3 | 3 |
| Sugar | 20 | 15 | 15 | 15 |
| Maltodextrin (MD) | | 5 | 5 | 4 |
| CITREM | 0.5 | | 0.5 | 0.5 |
| Water | 63.5 | 64 | 63.5 | 64.5 |
| Total | 100 | 100 | 100 | 100 |

In Table 5 PSD of the four vegan ice-cream mixes can be seen. D[3,2] is still around 2 μm except for mix 2c, whereas a mix of MD and Citrem gives a D[3,2] of 5 μm. D[4,3] is in the same range for all four samples varying from 20 to 25 μm. The best overrun, around 15%, was achieved when we used citrem and maltodextrin on its own, whereas when these components are mixed the overrun is lowered down to 10 and 3%.

The most sensational observation, however, is the creamy and smoothy consistency which was achieved when maltodextrin was added to the ice-cream, because for the vegan ice-creams usually it is difficult to obtain the creamy and smoothy consistency that dairy ice-cream generates.

TABLE 5
The properties of ice-creams with CITREM and MD and a combination thereof

| | | | | | Stand- | |
|---|---|---|---|---|---|---|
| | | D[3, 2] | D[4, 3] | Overrun | time | |
| Sample | Description | (μm) | (μm) | (%) | (min) | Sensorial comments |
| Vegan | 0.5% | 2.1 | 20.9 | 15.0 | 60 | Melting relatively |
| Ice- | citrem | | | | | quick in the mouth, |
| cream | | | | | | not so creamy, |
| mix 2a | | | | | | somewhat icy and |
| | | | | | | some off-taste |
| Vegan | 5% MD | 2.3 | 19.2 | 14.3 | 60 | Smoothy |
| Ice- | | | | | | |
| cream | | | | | | |
| mix 2b | | | | | | |
| Vegan | 0.5% | 5.1 | 22.3 | 9.3 | 60 | Smoothy |
| Ice- | citrem + | | | | | consistency, similar |
| cream | 5% MD | | | | | to ice-cream |
| mix 2c | | | | | | |
| Vegan | 0.5% | 1.9 | 24.8 | 3.4 | 90 | Smoothy |
| Ice- | citrem + | | | | | consistency, similar |
| cream | 4% MD | | | | | to dairy ice-cream. |
| mix 2d | | | | | | |

### Example 3

### The Influence of Varying the Protein and Citrem Content on the Properties of a Vegan Ice-Cream

### Compositions

In the experiments the pea protein (2 and 1.5% by weight) content was varied and the amount of Citrem (0.5 and 0.8% by weight) was also increased in two of the experiments. The other components were 12% by weight fat mix, 1% by weight potato flakes, 5% by weight maltodextrin and water adding up to 100%. There was, however, no difference in sensorially experienced taste and texture by the variation of pea protein and Citrem concentration.

With regard to the melting of the ice-creams measured as standing time the ice-creams can be divided roughly into three categories: commercial dairy ice-cream melts the quickest in half an hour, the vegan ice-cream with Citrem melts in an hour, whereas the addition of maltodextrin increases the melting time to one and a half hour. It is the potato in combination with maltodextrin together with all of the other components that provides the unique properties of the present vegan aerated emulsion i.e. vegan ice cream.

### Example 4

The Production of a Vegan Ice-Cream in a Pilot Plant and with the Variation of the Fat Phase

TABLE 6
The ground composition for the vegan ice-cream

| | Vegan ice-cream mix |
|---|---|
| Ingredients | (%) |
| Fat phase | 12 |
| Potato flakes | 1 |
| Pea protein | 3 |
| Sugar | 16 |
| MD (low DE) | 4 |
| Mono/diglyceride | 0.8 |
| Water | 63.2 |

TABLE 7
A description of the three fat phases used in the pilot plant trial

| Sample | Designation | Description | Comments |
|---|---|---|---|
| A | AkoLS25 | Sheabutter, | Shea butter is produced |
| | | rapeseed oil | from nuts from wild trees |
| | | | in Africa |
| B | Akoplanet PBI | Hydrated | Fully hydrated rapeseed |
| | 61-001 | rapeseed oil | oil without any trans fatty |
| | | | acids mixed with common |
| | | | swedish rapeseed oil. |
| C | XP6793 | Coca fat - | |
| | | rapeseed mixture | |

### Production of Vegan Ice-Creams

All the dry ingredients were mixed with water of 60° C. with a Silverson mixer for 5 minutes. The fat was slowly added to the mix with slow stirring (60% of max. rate) and thereafter mixing another 5 min. The pasteurization at 85° C. during 4 s and downstream homogenisation at 75° C. were performed. This vegan ice-cream mix was ripened overnight at 5° C. Before and after ripening the three types of vegan ice-creams studied were sensorially evaluated and the results can be seen in Table 8.

TABLE 8
Sensorially evaluated ice-cream mixes
before and after ripening overnight.

| | Taste and texture of the | Taste and texture of the |
|---|---|---|
| | ice-cream mixes before | ice-cream mixes after |
| Sample | ripening | ripening |
| A | Creamy, sweet and good | Creamy and sweet. |
| B | Creamy, less sweet | Creamy. |
| C | Creamy, less sweet | Creamy and moderate |
| | | sweetness |

All three samples were creamy with a sweet taste.

TABLE 9
The description of the vanilla aroma added, overrun
and the sensorially evaluation of the three ice-cream
samples after coming out of the ice-cream machine.

| | | | | Evaluation of the |
|---|---|---|---|---|
| | | | | ice-cream after |
| | | | | the ice-cream |
| Samples | Aroma | Taste aroma | Overrun[%] | machine |
| A | Vanilla | Sophisticated | 95 | Nice taste |
| | extract | | | |
| B | Vanilla | Good | 94 | Good vanilla |
| | aroma11253 | | | aroma |
| C | Vanilla | Too strong, | 92 | Nice taste. |
| | aroma veg. | gives a little | | Very creamy. |
| | | artificial taste | | |

Different vanilla aromas described in Table 9 were added to the three vegan ice-cream mixes with the same concentration of 2 g/kg (0.2%). In the ice-cream machine the air is let in by a valve before it goes into the scrape-heat exchanger having a cooling medium of −80° C. The ice-cream mix that came out of the machine had a temperature of −4° C. As seen in Table 9 the overrun was above 90% for all the samples and that is what usually is achieved in industrial production of ice-creams.

When a sensory tasting was made directly after the ice-cream came out of the machine the results of that tasting can be seen in Table 9. The experienced creaminess of the vegan ice-creams was excellent.

To ripen the ice-creams further they were put in a freezer of −40° C. over the week-end.

### The Characterisation of the Vegan Ice-Creams

The particle size distribution (PSD) was measured one day after the production of the three different vegan ice-creams and can be seen in Table 10, expressed as D[3,2] and D[4,3]. In Table 11 the PSD of the lab-made ice-cream and the industrially produced SIA ice-cream can be viewed.

TABLE 10
PSD for the three industrially produced ice-cream samples
A(AkoLS25), B (Akoplanet PBI61-001) and C(XP6793).

| Samples | D[3, 2] μm | D[4, 3] μm |
|---|---|---|
| A | 3.2 | 14.3 |
| B | 4.5 | 18.5 |
| C | 5.6 | 20.7 |

TABLE 11
PSD for the lab-made ice-creams and SIA ice-creams

| | D[3, 2] | D[4, 3] |
|---|---|---|
| Prov | (μm) | (μm) |
| SIA ice-cream | 1.9 | 58.1 |
| Lab-made ice-creams | 4.2 | 27.4 |
| 3% pea protein 4% | | |
| MD 0.8% citrem | | |

When comparing D[3,2] for the pilot-plant produced and the lab-produced ice-creams they are relatively similar varying between 3 to 6 μm, whereas the bought SIA ice-cream had smaller drops around 1.9 μm. However, for the larger particles or droplets expressed as D[4,3] the pilot-plant produced gave rise to smaller droplets around 15-20 μm, whereas the lab.-produced were more in the range of 30-40 μm. The SIA ice-cream had the largest D[4,3] being equal to 58 μm.

Sensory evaluation of the prepared vegan ice-creams A, B and C together with two industrially produced milk-based ice-creams (SIA and Triumf ice-cream) and a vegan ice-cream (oat based chocolate ice-cream) was performed by 4 assessors. They were evaluating icyness, taste, melting in the mouth, creamyness and total impression on a scale from 1 to 4. The results of this evaluation are presented in Table 12.

TABLE 12
Sensory evaluation of 6 ice-creams with regard to different
properties of the ice-creams and the total impression

| | | Off- | Melting in | | | Total |
|---|---|---|---|---|---|---|
| Sample | Icyness | taste | mouth | Creamyness | Colour | impression |
| A: Akomix | 1 | 2 | 4 | 4 | 3 | 4 |
| LS25 | | | | | | |
| B: Akoplanet | 1 | 2 | 4 | 4 | 3 | 4 |
| PBI 61-001 | | | | | | |
| C: XP6713 | 1 | 3 | 3 | 4 | 3 | 3 |
| SIA ice-cream | 2 | 4 | 4 | 3 | 2 | 3 |
| Triumf ice- | 2 | 4 | 4 | 3 | 2 | 2 |
| cream | | | | | | |
| Oat based | 1 | 4 | 1 | 2 | | 3 |
| Chocolate ice- | | | | | | |
| cream | | | | | | |

The striking result from this sensory investigation of the six ice-creams is that three vegan ice-creams A, B and C as prepared according to the present disclosure had superior creaminess compared to the other three ice-creams. Moreover, the melting in the mouth was similar for the milk-based ice-creams and ice-creams A, B and C, whereas the vegan oat based ice-cream was substantially less creamy. The best total impression of 4 was achieved for the ice-creams A and B as prepared according to the present disclosure compared to the other ice-creams.

Further comments during the sensory session were the following;
Ice-creams A, B and C kept the form very well in comparison to the other ice-creams.
Oat based ice-cream seemed more like a cake than an ice-cream. Some oat taste was observed.

### Melting Behaviour of the Ice-Creams

The results of the melting behaviour of a 2 cm thick ice-cream tablet of a diameter of 5 cm was measured as a function of time at room temperature up to 120 minutes and it can be seen in Table 13. The initial weight of the ice-cream tablet was registered and duplicates were performed for each ice-cream.

The striking observation that can be read from Table 13 is that the vegan ice-creams A, B and C, having both potato and maltodextin in comparison to the other two dairy ice-creams without, that the melting of the ice-creams is substantially lower for the former than for the latter. In the latter two dairy ice-creams a stabilisor, like different types of hydrocolloids such as carrageenan, have been added in the commercial available ice-creams but not in those prepared according to the present disclosure. The ordinary dairy ice creams named “Triumf” and “Sia” start to melt already after 15 minutes. The vegan ice creams A, B and C start to melt first at 60 minutes. This shows that there is a striking difference with regard to stabilizing effect when potato and maltodextrin is present in the composition. Still there is a better course of melting being slower, but still the melting in the mouth is high, which can be seen from the results given in Table 12. The vegan Ice-creams A, B and C would be very suitable for ice-cream sticks.

TABLE 13
The melting of different ice-creams as a function of standing time

| | standing time (min) | | | | | | | Initial |
|---|---|---|---|---|---|---|---|---|
| Samples | 15 | 30 | 45 | 60 | 75 | 90 | 120 | weight (g) |
| B (Akoplanet) | 0 | 0 | 0 | 0.15 | 0.42 | 0.38 | 0.46 | 18.6 |
| B (Akoplanet) | 0 | 0 | 0 | 0 | 0 | 0.05 | 0.05 | 19.8 |
| C (XP6713) | 0 | 0 | 0 | 0.28 | 0.5 | 0.56 | 0.62 | 22.6 |
| C (XP6713) | 0 | 0 | 0 | 0.05 | 0.05 | 0.06 | 0.06 | 23.3 |
| A (Akomix25) | 0 | 0 | 0 | 0.09 | 0.1 | 0.13 | 0.19 | 18.7 |
| A (Akomix25) | 0 | 0 | 0 | 0.1 | 0.22 | 0.32 | 0.4 | 23.4 |
| Triumf ice-cream | 0.73 | 1.16 | 2.24 | 2.84 | 3.3 | 3.86 | 4.17 | 16.6 |
| Triumfglass | 0.49 | 0.81 | 2.02 | 2.9 | 3.6 | 4.04 | 4.54 | 16 |
| SIA Ice-cream | 12 | 13.57 | 13.99 | 14.18 | 14.2 | 14.3 | 14.3 | 18 |
| SIA Ice-cream | 4.75 | 5.56 | 8.08 | 8.53 | 8.9 | 9.24 | 9.54 | 18.7 |

### Example 5

### Potato-Based Cooking Creams

Potato creams were prepared in this experiment with varying amounts of fat based mainly on potato flakes and pea protein, with the goal to produce a potato-based cooking cream. The fat used was AkoLS25 delivered by AAK. The used materials are shown in Table 14.

TABLE 14
Composition of potato-based cooking creams

| | Cream 1 | Cream 2 | Cream 3 |
|---|---|---|---|
| | (%) | (%) | (%) |
| Fat phase | 12 | 18 | 25 |
| Potato flakes | 1 | 1 | 1 |
| Pea protein | 3 | 3 | 3 |
| Sugar | 3 | 3 | 3 |
| MD (low DE) | 4 | 4 | 4 |
| Mono/diglyceride | 0.8 | 0.8 | 0.8 |
| (Citrem) | | | |
| Water (room | 76.2 | 70.2 | 63.2 |
| temperature) | | | |

The fat was melted in a microwave and mixed with the citrem for 10 s at full speed using a hand mixer. The remaining ingredients were then all added to the fat/citrem phase and mixed at full speed for 2 min, while kept in a warm water bath of 50° C. so the fats would remain in a liquid phase. The creams were kept in a 40° C. water bath until valve homogenization at 190/50 bar. The main difference is the fat content between the samples of potato cream, which is 12% for Cream 1, 18% for Cream 2 and 25% for Cream 3. This difference was clearly observed in the sensory analysis, as the thickness of Cream 3 was especially much higher than the other creams. Visually, the cream resembled almost of a yoghurt or mayonnaise in terms of thickness, which is much thicker than a whipping cream should be and therefore we can work with even lower fat content to make a whipping cream. However, when tasted it still appeared quite pleasant and not as thick as it looked. Cream 2 had a better thickness and creaminess than cream 1, but cream 3 had a slightly better flavor as the higher fat content was able to absorb some of the potato flavor.

On cooking the creams no precipitation occurred and a white and creamy consistency was observed. That makes these creams very suitable as a cooking cream.

### Example 6

### Potato-Based Whippable Creams

### Composition

Emulsions were prepared according to the recipes in Table 15. The fat was first microwaved until completely melted and mixed with the CITREM at full speed for 30 s using a handmixer. The dry ingredients were mixed together with warm water (around 50° C.) and also mixed using a handmixer at full speed for 1 min. Then the blender attachment from the kitchen machine (Bosch® MUMS2EW00) was used to mix the sample while slowly adding the fat-phase to the water-phase. The mixture was mixed at medium-high speed for 3 minutes in the blender.

TABLE 15
Composition of the creams

| | C6 - | C8 - | C9 - | C10 - | C11 - |
|---|---|---|---|---|---|
| | 12% | 20% | 14% | 16% | 18% |
| Ingredient | fat | fat | fat | fat | fat |
| Fat phase | 12 | 20 | 14 | 16 | 18 |
| (AkoPlanet PBW 119) | | | | | |
| Potato flakes | 1 | 1 | 1 | 1 | 1 |
| Pea protein (Pe) | 3 | 3 | 3 | 3 | 3 |
| Sugar | 3 | 3 | 3 | 3 | 3 |
| MD (low DE) | 4 | 4 | 4 | 4 | 4 |
| Mono/diglyceride (Citrem) | 0.8 | 0.8 | 0.8 | 0.8 | 0.8 |
| Cream flavor | — | — | — | — | 0.15 |
| Water | 76.2 | 68.2 | 75 | 73 | 71 |

The samples were stored in the fridge until the homogenization experiments the next day. To imitate the pasteurization step in a production, the samples were placed in an 80° C. water bath for 20-30 minutes prior to the actual homogenization. A thermometer was used to determine that the creams had reached a temperature of 80° C.

For samples C8, a pressure drop of 200/50 bar has been used during homogenization. The creams C9-C11 were homogenized at 600/50 bar.

### Whipping the Creams and Overrun

After homogenization, the samples were stored in the fridge overnight prior to the whipping. The Bosch® MUMS2EW00 kitchen machine was used at speed setting 4 to whip the creams. The samples were whipped until stiff peaks were observed. All the results are collected in Table 16

For this experiment, a new fat from AAK, AkoPlanet PBW, was used instead of Akomix LS 25. Akomix LS 25 (rapeseed oil and shea butter) has a solid fat content of 19% at room temperature, whereas AkoPlanet PBW 1 has a solid fat content of 82% at this temperature. The fat characteristics play an important role in creating a whipped cream with favorable qualities, since the fat stabilizes the air bubbles in the foam. If the solid fat content is too low, the liquid fat will accumulate too fast resulting in an unstable foam. A higher solid fat content can be favourable for foam stability, but for a better mouthfeel it is important that the fat melts at the temperature in your mouth. Therefore, a balance between the solid and liquid phase in the fats is key when producing a whipped cream.

From the results presented in Table 16, it is clear that this new fat is able to produce a whippable cream based on potatoes. Furthermore, these results show that the amount of fat in the cream greatly impacts the whippability, whipping time, mouthfeel, and also the overrun. Successful whipping was achieved with a minimal fat content of 14%, but the whipped cream is slightly heavier when 18-20% fat was added. It seems that 14-16% fat results in the best whipped cream, based on the results. The whipping time required to create a stable foam also depended on the fat content. The higher the fat content, the shorter the whipping time required.

### Creams Compared to Benchmarks

When developing a novel whipped cream, it is important to know how such whipped cream compares to the existing creams on the market. In this section, the whippable creams of the invention are compared to dairy whippable cream and Oatly iMat visp (whippable oat cream). The particle size, overrun, and overrun loss are all shown in FIG. 3.

The particle size results of C9 (14% fat) are similar to those of Oatly and dairy whipped cream. Dairy whipped cream has a higher D(3,2) compared to C9 and Oatly whipped cream. The other potato creams have higher particle sizes.

The overrun of the whipped vegan creams of (14 and 16% fat) is also comparable to the benchmarks. The overrun of the potato whipped creams of 14% fat was similar to that of the Oatly whipped cream, where the overrun of these two plant-based creams is higher than that of the dairy.

The stability of the whipped creams was based on the overrun loss after 24 hours in the fridge (FIG. 3D). This graph shows that the stability of potato cream with 14% fat (C9)) is comparable to that of the benchmarks.

FIG. 3E displays the whipping time for the creams until maximum overrun was reached (approximately). The whipping time of most potato creams was higher than that of the benchmarks, only the sample with 20% fat (C8) had a comparable whipping time. However, the potato based whipped cream achieved already at such low fat content of 14% a whippable cream, whereas the Oatly whipped cream needed a fat content of 23% and the dairy whipped cream needed a fat content of 36%.

Overall, the graphs in FIG. 3 show, that our potato-based cream of 14% fat has very comparable values to the benchmarks.

1. A vegan, non-dairy composition comprising;
0.1-2% by weight heat treated, dehydrated potato as a stabilizer;
8-40% by weight vegetable fat mix;
2-25% by weight of at least one sweetening agent;
0.5-5% by weight of at least one added vegetable protein;
0.2-1.2% by weight mono- or diglyceride, or mixture thereof;
1-8% by weight maltodextrin; and
water adding up to 100% by weight.

2. A vegan, non-dairy composition according to claim 1, wherein the heat treated potato is chosen from potato flakes which have been heated to at least 100° C. or whole and/or potato cubes which have been pasteurized at at least 98° C., and thereafter dehydrated.

3. A vegan, non-dairy composition according to claim 1, wherein the at least one sweeting agent is a sugar selected from the group consisting of monosaccharide, disaccharide, polysaccharide and polyol.

4. A vegan, non-dairy composition according to claim 1, wherein the maltodextrin has a low dextrose equivalent (DE) such as 1-5 DE.

5. A vegan, non-dairy composition according to claim 1, wherein the at least one added vegetable protein is selected from the group consisting of pea protein, potato protein, and soy protein.

6. A vegan, non-dairy composition according to claim 1, wherein the composition further comprises a flavoring agent.

7. A vegan, non-dairy composition according to claim 1, wherein the mono- and diglyceride is selected from the group consisting of lactic acid esters of mono- and diglycerides, and citric acid esters of mono and diglycerides.

8. A vegan, non-dairy composition according to claim 1, wherein the composition additionally comprises a pH regulating agent.

9. A vegan, non-dairy composition according to claim 1 comprising;
0.75-1.25% by weight heat treated, dehydrated potato as a stabilizer;
10-20% by weight vegetable fat mix,
2-15% by weight sweetening agent;
1-3% by weight added vegetable protein;
0.5-1% by weight mono- or diglyceride;
2-5% by weight maltodextrin; and
water adding up to 100% by weight.

10. A composition according to claim 1, wherein the composition is in the form of an emulsion.

11. Use of a vegan, non-dairy emulsion according to claim 10, wherein the vegan, non-dairy emulsion is aerated to provide a stable foam.

12. An aerated, optionally frozen, vegan non-dairy emulsion according to claim 10.
